(19) United States
(12) Patent Application Publication
(10) Pub. No.: US 2004/0179233 A1
(43) Pub. Date: Sep. 16, 2004

(54) Photo kiosk

(76) Inventor: John A. Vallomy, Concord, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/794,836

(22) Filed: Mar. 5, 2004

Related U.S. Application Data
(60) Provisional application No. 60/453,867, filed on Mar. 11, 2003.

(51) Int. Cl. G06F 15/00; H04N 1/23

(52) U.S. Cl. 358/1.15; 358/302

(57) ABSTRACT

A photography booth apparatus and a picture making method which enables a person subjects to purchase a high quality self-portrait photograph from an unattended kiosk in a retail environment. The apparatus includes a computer system for operatively connecting and controlling all elements of the apparatus; payment apparatus connected to the computer system; a digital camera operatively connected to the computer system; a mirror interposed between the subject and the digital camera through which images are captured for further processing in the computer system; a display monitor operatively connected to the computer system for presenting guidance to the subject by presenting choice selections and for displaying tentative portraits for approval by the subject; and photograph printing means operatively connected to the computer system for providing portraits of and to the subject. The resulting self-portrait has the attributes of selectable pose, selectable background, selectable print size and/or selectable border.

### CROSS REFERENCE TO RELATED APPLICATION

This application claims the benefit of U.S. Provisional Application No. 60/453,867, filed Mar. 10, 2003.

### FIELD OF INVENTION

This invention relates to subject-activated photography, and more particularly to the making of self portraits in a booth or kiosk dedicated to that purpose. The invention, hereinafter referred to as Photo Booth, delivers a high quality photograph, immediately and economically to a consumer or subject without outside personal assistance, while allowing the subject to select poses, lighting effects, and varying backgrounds from a prerecorded set, and then allows selection of print orders, including print sizes.

### BACKGROUND OF THE INVENTION

To purchase a portrait of oneself, a subject currently has three options: 1) to have his portrait taken by a commercial photographer, 2) to visit a retail store that offers instant photos, or 3) to visit a kiosk that delivers instant images. Unfortunately for the subject, the hassle and expense of commissioning a portrait by a professional is high and the instant photo kiosk delivers a poor quality image with few options. For example, one overall light floods the subject(s) with light, resulting in displeasing, unattractive lighting. The retail stores offering instant photographs also deliver an image by a Polaroid type device or a poor digital printout, with no further options. Photo Booth eliminates these negatives of the photo experience.

Photo Booth is a unique process and apparatus using computer-based imaging technology and a subset of imaging software. There is currently no digital photo station available that consistently delivers an immediate, high quality image to the subject at a reasonable cost. Photo Booth eliminates the inconvenience and expense of contracting a photographer or scheduling a photo session at a commercial studio. A compatible, equally well-lit image can be produced at the Photo Booth. Materials and billable time are diminished since the subject directly chooses the expression and pose desired. The need to train and compensate employees is eliminated. There are minimum re-takes or rejects, since the subject preselects the final image and only then is the image printed. A natural and pleasing expression is obtained since the subject visualizes the pose and “look” via a built-in mirror and on a computer monitor. Any apprehension about being photographed by a stranger is eliminated. The subject actually becomes the photographer. Photo Booth also allows privacy to the camera shy. There is no stand-alone device on the market that allows the subject to select an appropriate background for a photograph of his person without assistance. This enables Photo Booth to offer photographs for passports, immigration, work Identification Cards, social photographs, and also general portraits, etc., to the subject.

### SUMMARY OF THE INVENTION

The invented Photo Booth is a method and apparatus that permit a subject to use a stand-alone alone kiosk installed in retail space such as a shopping mall to obtain a photograph featuring selectable lighting effects, selectable backgrounds, selectable sizes, and selectable number of prints as well as special features such as borders and themes with an Automatic-Teller-Machine (ATM)-like subject interface. The invented apparatus is composed of a personal computer with prepayment hardware, lighting systems, a digital camera, a mirror having a small orifice through which the camera lens is aimed at the subject, prerecorded images for background and borders and a photo-printer operatively attached and built into a specialized kiosk. The invented method ergonomically guides the subject through a limited number of photographic options producing a photo-print. The photo-print may be used for passports, immigration papers, work identification (IDs), portraits, or any other purpose.

### OBJECTS OF THE INVENTION

The principal object of the invention is to provide a method and apparatus for producing a high quality self-portrait photograph.

It is another object of the invention to provide a method and apparatus whereby a subject or subjects may obtain a high quality self-portrait photograph from an unattended kiosk in a retail environment.

It is also an object of the invention to provide a method for a subject to create a self-portrait having a selectable pose, selectable background, selectable lighting effects, selectable print size and/or selectable border.

### BRIEF DESCRIPTION OF THE DRAWINGS

The present invention may be better understood by reference to the following detailed description and to the accompanying drawings in which:

FIG. 1 is a diagrammatic cutaway side view of the invented apparatus.

FIG. 2 is a diagrammatic top view of the apparatus of FIG. 1.

FIG. 3 is a diagrammatic elevation view of the reflection of a subject on a mirror inside the invented apparatus.

FIG. 4 is an isometric view of an alternative exterior of the invented apparatus.

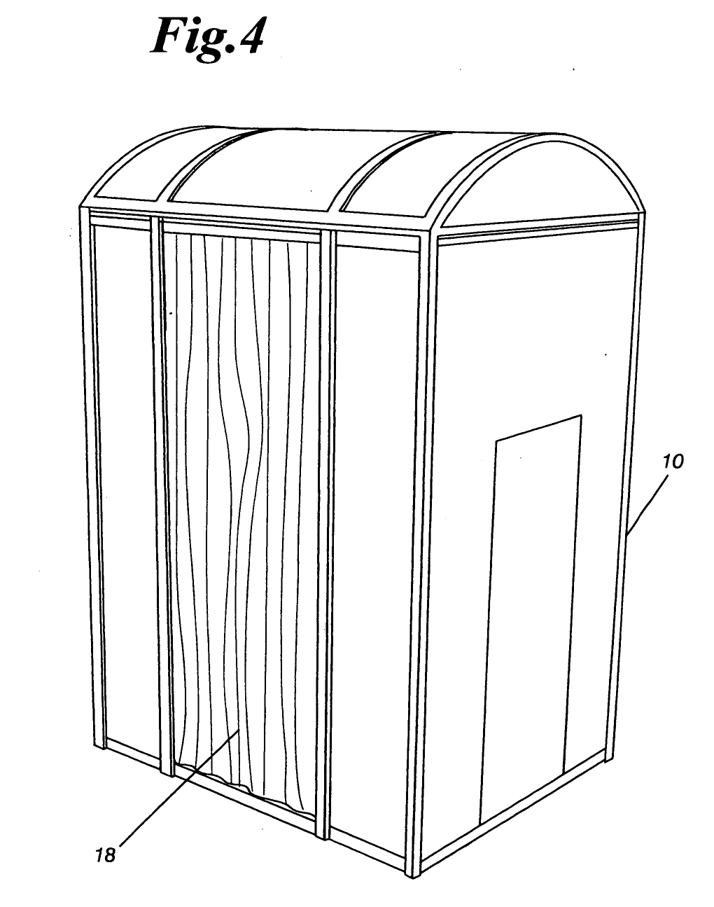

FIG. 5 is a flow chart showing the steps in the invented method of making a composite photograph which has a user-selected background and user-selected size which is made and presented to the subject by an unattended machine.

### DETAILED DESCRIPTION

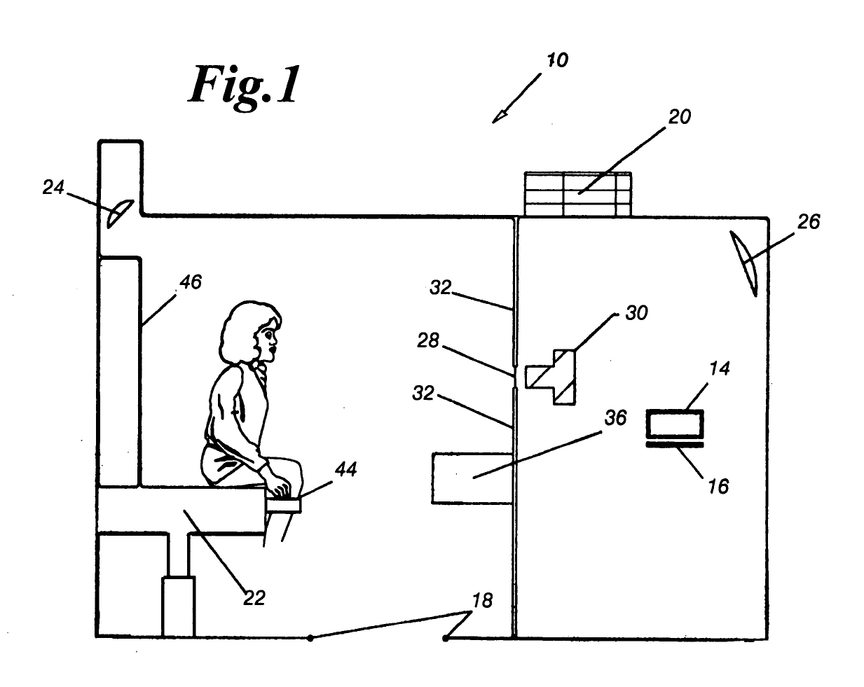

Referring now to the drawings and particularly to FIG. 1, the invented apparatus which implements the invented method is composed of a booth or kiosk 10, which is preferably provided with a sign containing instructions. Basic operational procedure can be displayed on the exterior of the booth, and photographing, posing, background, and other instructions on the interior sidewall of the booth. The various operations of the apparatus are controlled by a computer, preferably located within the kiosk structure 10. An associated prepayment means 14, preferably having a device for receiving currency (preferably both coins and bills) including apparatus to issue change, in addition to credit and/or debit card reader-recorders similar to a credit card station at a gas pump or a debit card station at an ATM, is operatively connected to the computer. Upon the user making or arranging prepayment using the prepayment means, a receipt is issued by a printer 16. The receipt may contain a purchase code that may be machine readable. The kiosk 10 is accessible through a latching booth entry door 18. The door 18 preferably latches with an electro-mechanical lock connected to the computer. The door 18 is unlatched upon proper prepayment, allowing the subject(s) to enter the Photo Booth. Alternatively, the door 18 is unlatched upon presentation of the previously issued receipt to a electronic scanning device. An “in-use” sign 20 is illuminated as the subject enters the Photo Booth.

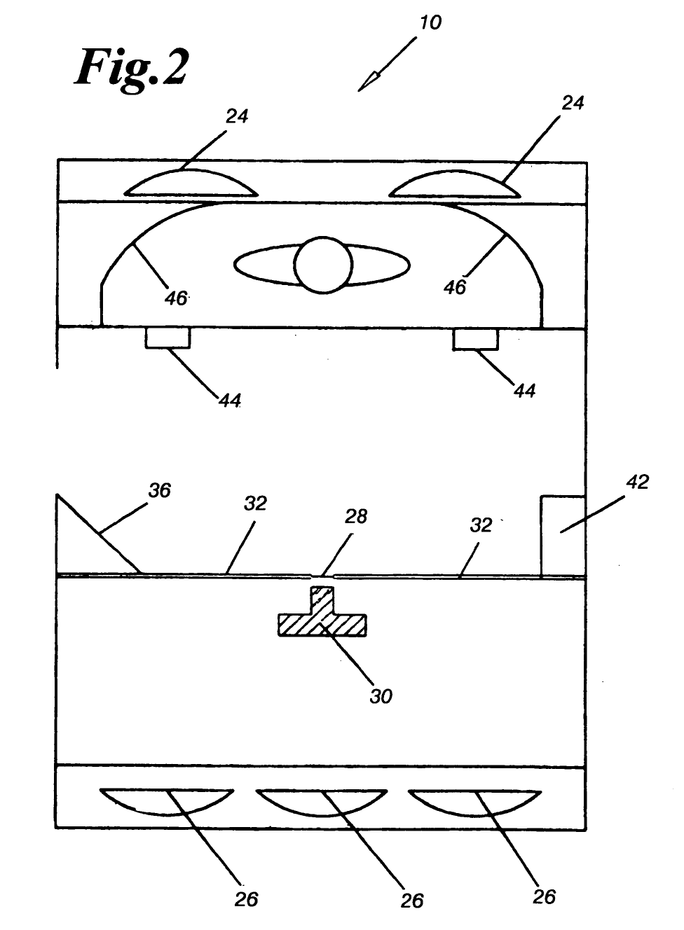

Referring to FIG. 2, apparatus 10 includes a seat 22 for positioning the subject(s). The seat 22 is adjustable, which may be by a series of adjustable seat supports, but preferably by an electrical lifting/lowering device or gas-operated adjustment device. Illumination sources 24 may be mounted in the rear of the kiosk and directed at the subject's hair for highlighting and/or shadow elimination. A camera 30 is mounted within the kiosk 10 opposite the rear of the kiosk 10. The camera is preferably a digital camera. The camera is mounted behind a mirror 32, with the lens of the camera 30 located behind and directed toward a small aperture 28 in the mirror 32. Additional lighting is provided by front illumination sources 26 mounted on the same side of the booth as the camera 30. All of the functional devices are operatively connected to the computer system.

A selection means 36, preferably a computer monitor fitted with a touch-screen, is provided to facilitate subject interaction with the computer system. The subject may select from a plurality of lighting effects, for example, portrait mode or more dramatic lighting effects. The light used is diffused light, preferably fluorescent. The background surface 46 behind the subject(s) consists of a monochromatic reflecting surface, usually saturated blue or green. The computer system treats the monochromatic background 46 as background and any and all colors that differ from the monochromatic surface 46 as foreground.

The computer system has a repertoire of backgrounds, for example, forest scenes, seashore, cityscapes, and so forth, which may electronically interposed over the image of the monochromatic surface 46. The computer then composes a composite picture by forming a logical operation on each picture element, namely, F V \overline{F}ΛB where F represents the foreground and B represents the background. Thus, the composite picture shows the subject(s) against any of a variety of prerecorded backgrounds.

As mentioned, the camera 30 is positioned behind mirror 32, and is directed through aperture 28 in the mirror. The subject (or subjects) may properly position himself using his reflection and guide markings on the mirror 32. Alternatively, a preview of the image that would be captured by the camera if the shutter were activated is seen on the monitor 36 and the subject may further adjust his position and appearance using this visual feedback.

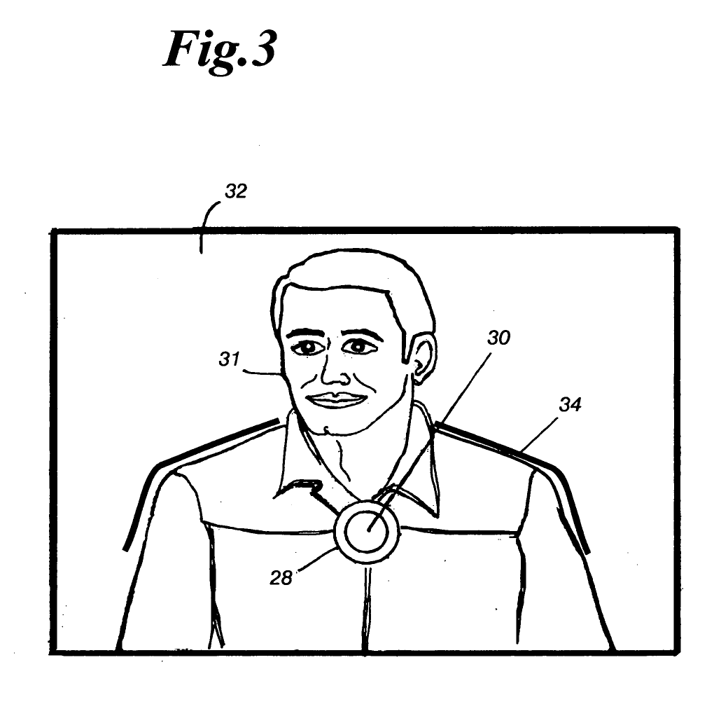

Referring to FIG. 3, a subject may pose himself in two ways. The subject may refer to his reflection 31 and guide markers 34 on the mirror 32, or he may refer to the continuous feed of the image of the digital camera as displayed on the monitor 36. The computer has the ability to display the subject image over the superimposed background that the subject has selected on the monitor 36. Once the subject is satisfied with the image, an actuator such as button 44 is engaged which signals the computer to capture the image with the digital camera. By operating an appropriate control, preferably upon the touchscreen 36, the subject may accept the image or may retake the image a limited number of times.

Once the subject is satisfied with the captured image, backgrounds may be added and the image may be electronically cropped in a number of prerecorded geometric shapes. Also, the image may be “framed” in any of a number of prerecorded borders that may have a theme such as “birthday.” Once the complete image is satisfactory to the subject, the subject may choose a desired print size up to a maximum, for example, 11×14-inches. The maximum print size and the resolution of the digital camera are related. For example, a minimum of 200 picture elements (pixels) per inch in the portrait is a rule-of-thumb. The screen displays a message such as “Done, step outside” or the equivalent and the subject exits the booth. Alternatively, delivery of the print may be to the interior of the booth, if desired.

Referring again to FIG. 2, the print is delivered to the subject via a delivery device, shown as delivery slot 42. The image may be rendered using ink-jet printing on special papers to insure quality, or on any suitable printer.

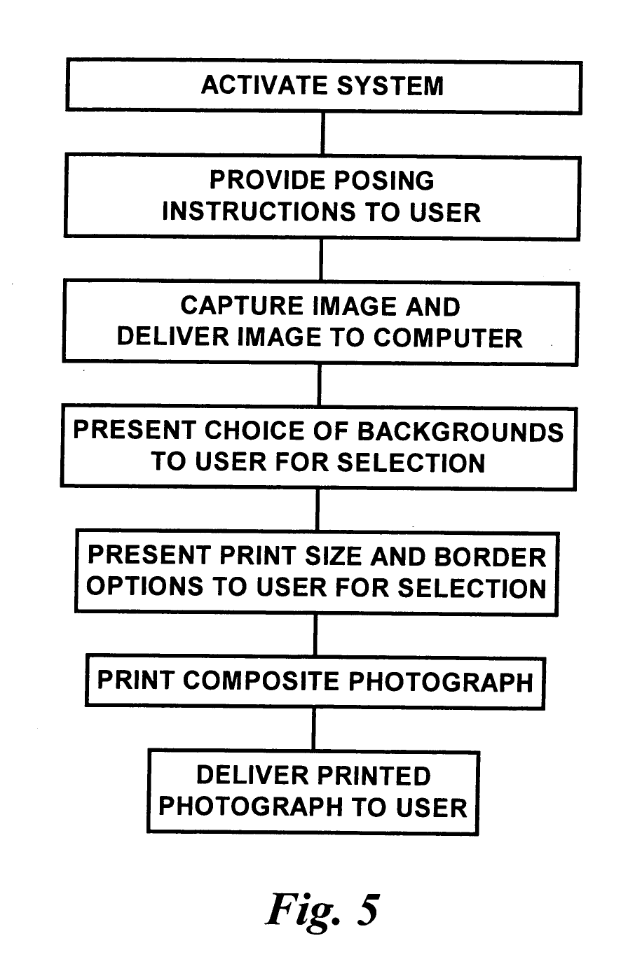

The steps of the invented method are outlined in the chart shown in FIG. 5. These steps for automatically photographing a subject, which is usually a person, are:

a. activating the computer-operated photography system, which can be as simple as switching it on, but preferably activation is accomplished by accepting a prepayment from the user by utilizing payment accepting means operatively connected to a computer system;

b. providing instructions to the subject to guide the subject through tentative positions and poses using guide marks on the mirror which is arranged to face the subject;

c. capturing an image of the subject using a digital camera operatively connected to the computer system;

d. presenting a variety of backgrounds to the subject to guide the subject through a selection of prerecorded backgrounds to be printed behind the image of said subject, and allowing the subject to select the desired background;

e. presenting a catalog of final print size options to the subject for selection of a desired print size from the available print sizes; and,

f. printing a composite photograph having the chosen image of the subject, the chosen image of the selected background, and the selected print size. This method results in a composite photograph being made and presented to the subject by an unattended machine.

### Summary of the Achievement of the Objects of the Invention

From the above, it is clear that I have clearly invented a method and apparatus whereby a subject or subjects may create, take, and print an advanced self-portrait photograph having previously unavailable attributes of selectable poses, selectable backgrounds, selectable lighting effects, selectable print size and/or selectable borders from an unattended kiosk in a retail environment.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. An apparatus for automatically photographing a subject which comprises:
(a) a computer system for operatively connecting and controlling all elements of said apparatus;
(b) means operatively connected to said computer system for activating said apparatus;
(c) a camera operatively connected to said computer system;
(d) means for locating at least one subject with regard to said camera;
(e) a mirror interposed between the subject locating means and said camera, and being provided with an opening therein through which said camera is directed, and through which images are captured for further processing in said computer system;
(f) a display monitor operatively connected to said computer system for presenting menus of choices to the subject and also for displaying tentative portraits for approval by the subject;
(g) menu interaction means operatively connected to said computer system for registering choices by the subject; and
(h) photograph printing means operatively connected to said computer system for providing portraits approved by the subject, said printing means being responsive to the registered choices; whereby a composite photograph is created, taken, and presented to the subject by said apparatus.

2. Apparatus according to claim 1 wherein the means operatively connected to said computer system for activating said apparatus is a means for accepting prepayment.

3. Apparatus according to claim 2 wherein the means for accepting prepayment comprises a currency acceptor with capability for providing change.

4. Apparatus according to claim 2 wherein the means for accepting prepayment comprises a credit/debit card reader with capability for verifying credit worthiness and/or account sufficiency.

5. Apparatus according to claim 1 further comprising enclosure entry control means operatively connected to said computer system for admitting the subject after prepayment.

6. Apparatus according to claim 5 wherein the enclosure entry control means consists of an electro-mechanical door lock operatively connected to said computer system.

7. The apparatus according to claim 1 further comprising guide markers on said mirror to assist the subject in posing and positioning the subject in front of said camera.

8. Apparatus according to claim 1 further comprising lighting means operatively connected to said computer system for effecting a plurality of illumination choices.

9. Apparatus according to claim 1 wherein said camera is a digital camera.

10. Apparatus according to claim 1 wherein said means for locating at least one subject with regard to said camera is an adjustable height seat.

11. Apparatus according to claim 1 further comprising a monochromatic backdrop located opposite said camera with respect to said subject; and
means for said computer system to differentiate between foreground and background thereby enabling the addition of prerecorded backgrounds to the finished portrait.

12. Apparatus according to claim 1 wherein the menu interaction means comprises a touch screen enabling said subject to register selections by touching the desired selection on the screen.

13. Apparatus according to claim 11, further comprising a selection means for registering final acceptance of the tentative portrait.

14. Apparatus according to claim 1 wherein said photograph printing means consists of an ink-jet printer.

15. A method for automatically photographing a subject which comprises:
(a) accepting a prepayment for said photographing using payment accepting means operatively connected to a computer system;
(b) providing feedback to the subject to guide the subject through tentative positions and poses using guide marks on a mirror arranged to face the subject;
(c) capturing an image of said subject using a digital camera operatively connected to said computer system;
(d) presenting a repertoire of backgrounds to said subject to guide said subject through tentative prerecorded backgrounds to be printed behind the image of said subject;
(e) presenting a catalog of final print sizes to said subject to guide said subject to an available desired print size; and,
(f) printing a composite photograph having both the chosen image of the subject and the chosen image of the selected background; whereby a composite photograph is presented to said subject by an unattended machine.

16. A method according to claim 15, further comprising: presenting a repertoire of thematic borders to said subject to guide said subject through a set of prerecorded borders to frame said composite photograph.

17. A method according to claim 15, wherein prepayment is accepted in currency with provision for providing change.

18. A method according to claim 15, wherein prepayment is effected by accepting a credit or debit card.
